(19) United States
(12) Patent Application Publication
(10) Pub. No.: US 2007/0097552 A1
(43) Pub. Date: May 3, 2007

(54) Hard disk drive and flexible printed circuit ribbon thereof

(76) Inventors: Haeng-soo Lee, Suwon-si (KR); Yong-kyu Byun, Yongin-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/582,386

(22) Filed: Oct. 18, 2006

(30) Foreign Application Priority Data
Oct. 31, 2005 (KR) 10-2005-0103258

(51) Int. Cl. G11B 5/48

(52) U.S. Cl. 360/245.9

(57) ABSTRACT

A hard disk drive (HDD) includes at least one data storage disk, a spindle motor to which the disk is mounted for rotating the disk, an actuator including a read/write head and a swing arm for moving the read/write head to a predetermined position on the disk for recording/reproducing data, a flexible printed circuit ribbon having a free bending portion and connected to the actuator for transmitting electrical signals to the actuator, and a bracket connecting the flexible printed circuit ribbon to a circuit board. The free bending portion extends over at least one part of the length of the flexible printed circuit ribbon and is thinner than other portions of the flexible printed circuit ribbon. Therefore, the flexible printed circuit ribbon offers minimal resistance to the rotation of the swing arm of the actuator due to its enhanced flexibility. Owing to the improved flexible structure of the flexible printed circuit ribbon, the HDD can drive the actuator with a higher efficiency and provides greater performance with respect to the operation in which the read/write head seeks out a particular track on the disk.

### BACKGROUND OF THE INVENTION

1. Field of the Invention

The present invention relates to a hard disk drive. More particularly, the present invention relates to the actuator of a hard disk drive for moving a read/write head to a desired position over a disk of the drive.

2. Description of the Related Art

A hard disk drive (HDD) reproduces data from a disk or records data on the disk using a read/write head. To this end, the read/write head is moved by means of an actuator to a desired position above a recording surface of the disk while the disk is rotated. FIG. 1 is a perspective view of an essential portion of an HDD having a conventional actuator. Referring to FIG. 1, the HDD includes a data storage disk 50, a spindle motor 55 for rotating the disk 50 at a constant angular speed (Ω), a read/write head 38, and an actuator 30 for moving the read/write head 38 to a desired position over the disk 50. The actuator 30 includes a swing arm 32 rotatably supported by a pivot 31, a suspension 35 installed on a leading end of the swing arm 32 for supporting and elastically biasing the read/write head 38 toward a surface of the disk 50, and a voice coil motor (VCM) for rotating the swing arm 32. The VCM includes a VCM coil 41 disposed on a rear end of the swing arm 32, and magnets 75 disposed above (not shown) and below the VCM coil 41 so as to face the VCM coil 41. The VCM coil 41 is coupled to a coil support 45 provided on the rear end of the swing arm 32. Reference numeral 71 denotes a yoke supporting the magnet 75 disposed below the VCM coil 41. The VCM rotates the swing arm 32, in a direction according to Fleming's left-hand rule, due to the interaction of the magnetic field induced by the current flowing through the VCM coil 41 and the magnetic field formed by the magnets 75.

In operation, when the HDD is powered on and the disk 50 is rotated, the VCM rotates the swing arm 32 counterclockwise, for example, to move the read/write head 38 to a position above a recording surface of the disk 50. The read/write head 38, which is loaded above the disk 50 in this way, is maintained a predetermined distance from the surface of the disk 50 by a lift force generated by the rotation of the disk 50. In this state, the read/write head 38 records data on the recording surface of the disk 50 or reproduces data from the recording surface of the disk 50, as it traces a particular track (T) of the disk 50.

On the other hand, when the HDD is powered off and the disk 50 is not rotated, the VCM rotates the swing arm 32 in the opposite direction, e.g., clockwise. Accordingly, the read/write head 38 is unloaded from the recording surface of the disk 50 and parked on a ramp 60 disposed radially outwardly of the disk 50. In this unloading operation, an end (tab) 39 of the suspension 35 slides along the ramp 60 to a safe position, and then rests on a supporting surface of the ramp 60.

In addition, a flexible printed circuit ribbon 20 is connected to one side of the swing arm 32 of the actuator 30 to supply power to the actuator 30 and to send/receive electrical signals to/from the actuator 30. Specifically, one end of the flexible printed circuit ribbon 20 is connected to and supported by the actuator 30. The other end of the flexible printed circuit ribbon 20 is connected to and supported by an upright leg 83 of a bracket 80 disposed close to the actuator 30. The middle of the flexible printed circuit ribbon 20 is thus relatively free to bend.

The flexible printed circuit ribbon 20 includes a plurality of conductive line patterns through which different electrical signals are transmitted. For example, the conductive line patterns include a head signal line pattern through which electrical signals are sent to and received from the read/write head 38, a ground line pattern for grounding the electronics, and a driving current line pattern through which current is supplied to the VCM. A printed circuit board (not shown) is disposed under the bracket 80, and is connected with the conductive line patterns of the flexible printed circuit ribbon 20 through the bracket 80.

Generally, the flexible printed circuit ribbon 20 has a length sufficient to allow the swing arm 32 to rotate without disturbing the swing arm 32. That is, the flexible printed circuit ribbon 20 bends as the swing arm 32 rotates in one direction, e.g., in the clockwise direction, and is extended as the swing arm 32 rotates in the opposite (e.g., counterclockwise) direction. Nonetheless, a restoring force is exerted on the swing arm 32 by the flexible printed circuit ribbon 20 when the flexible printed circuit ribbon 20 is bent, due to the elasticity of the flexible printed circuit ribbon 20. On the other hand, a tensile force is exerted by the flexible printed circuit ribbon 20 on the swing arm 32 when the flexible printed circuit ribbon 20 is extended.

Accordingly, these so-called bias forces, which are exerted on the swing arm 32 by the flexible printed circuit ribbon 20, act to resist the rotation of the swing arm 32 when the swing arm 32 is loaded and unloaded. Therefore, the VCM has to exert a driving force on the swing arm 32 that is sufficient to overcome the bias forces produced by the flexible printed circuit ribbon 20. In particular, the driving current supplied to the VCM coil 41 must be great enough to provide the required dynamic characteristics of the actuator 30 such as the ability of the actuator to provide a rapid response. Thus, the conventional actuator 30 consumes a relatively great amount of power and operates at a correspondingly low efficiency.

Furthermore, the flexible printed circuit ribbon 20 is preferably assembled in an upright position perpendicular to a base of the housing of the HDD. However, the side of the actuator 30 to which an end of the flexible printed circuit ribbon 20 is connected or the leg 83 of the bracket 80 to which the other end of the flexible printed circuit ribbon 20 is connected is not perpendicular to the base, due to manufacturing tolerances, for example. Similarly, one or the other end of the flexible printed circuit 20 ribbon is not fitted tightly against the actuator 30 or the leg 83 of the bracket 80. Therefore, in any of these cases, the flexible printed circuit ribbon 20 assumes a twisted disposition.

FIG. 2 is a plan view of the flexible printed circuit ribbon 20 when it is twisted. The twist of the flexible printed circuit ribbon 20 negates the ideal relationship between the magnitude of the driving current supplied to the VCM and the angle over which the swing arm 32 is rotated by the VCM. That is, the read/write head 38 is not be precisely moved to a target track of the disk 50 when the flexible printed circuit ribbon 20 when it is twisted. Consequently, there is a time delay in moving the read/write head 38 to the target track of the disk 50.

### SUMMARY OF THE INVENTION

An object of the present invention is to provide a hard disk drive having an actuator that can be driven with a high degree of efficiency.

Another object of the present invention is to provide a hard disk drive which offers improved data seeking performance.

Still another object of the present invention is to provide a flexible printed circuit ribbon whose flexibility is enhanced.

According to an aspect of the present invention, there is provided a hard disk drive having at least one data storage disk, a spindle motor to which the disk is mounted, an actuator including a read/write head and an arm for moving the read/write head over the disk, a support member that is fixed in the hard disk drive, and a flexible printed circuit ribbon having a free bending portion. The flexible printed circuit ribbon is connected to the arm so as to move therewith and is to the fixed support member. The free bending portion is provided along the length of the ribbon between locations at which the ribbon is connected to the swing arm and the support member. The free bending portion is substantially thinner than other portions of the flexible printed circuit between those locations at which the ribbon is connected to the swing arm and the support member. Accordingly, the free bending portion imparts an increased flexibility to the ribbon to attenuate a force exerted on the arm by the flexible printed circuit ribbon.

The flexible printed circuit may include a first supported portion abutting and supported on the arm of actuator, a second supported portion abutting and supported on the fixed support member, and a connecting portion interconnecting the first and second supported portions. The connecting portion is freely suspended between the first and second supported portions so as to be free to bend and extend as the arm moves relative to the fixed support member. The free bending portion constitutes part of the connecting portion.

According to another aspect of the present invention, there is provided a flexible printed circuit ribbon including a conductive layer extending along the length of the ribbon, and a first protective layer and a second protective layer disposed over opposite sides of the conductive layer, respectively, and wherein the flexible printed circuit ribbon has first and second end portions to which the conductive layer extends, and a free bending portion located along the length of the ribbon between the first and second end portions. The free bending portion is substantially thinner than other portions of the flexible printed circuit ribbon located between the first and second end portions. Thus, the free bending portion imparts an increased flexibility to the ribbon.

According to either of these aspects of the present invention, the conductive layer preferably has substantially the same thickness over the entire length of the flexible printed circuit ribbon. At least one of the first and second protective layers is thinner at the free bending portion than at other portions of the flexible printed circuit ribbon. Alternatively, or in addition, at least one of the first and second protective layers has a discontinuity at the free bending portion. Preferably, the flexible printed circuit ribbon also has a respective bonding layer interposed between at least one of the first and second protective layers and the conductive layer for bonding the conductive layer to the protective layers.

### BRIEF DESCRIPTION OF THE DRAWINGS

The above and other objects, features and advantages of the present invention will become more apparent from the following detail description of the preferred embodiments thereof made with reference to the attached drawings in which:

FIG. 1 is a perspective view of essential parts of a conventional hard disk drive (HDD);

FIG. 2 is a plan view of a flexible printed circuit ribbon of the conventional HDD of FIG. 1;

FIG. 3 is a perspective partially exploded view of an embodiment of an HDD according to the present invention;

FIG. 4 is a plan view of the HDD of FIG. 3;

FIG. 5 is a perspective view of a main portion of an actuator of the HDD of FIG. 3;

FIG. 6 is a plan view of a flexible printed circuit ribbon of the HDD of FIG. 3 and depicted in FIG. 5;

FIG. 7 are sectional views of the flexible printed circuit ribbon as taken along lines A-A′ and B-B′ of FIG. 6, respectively;

FIGS. 8 and 9 are graphs showing bias force with respect to angle of rotation of a swing arm according to the prior art and the present invention, respectively;

FIG. 10 is an explanatory diagram including a plan view of the swing arm of the HDD illustrating the angle of rotation of the actuator of an HDD;

FIG. 11 is a longitudinal sectional view of a segment of the flexible printed circuit ribbon depicted in FIG. 3; and

FIG. 12 is a longitudinal sectional view of a segment of another form of a flexible printed circuit ribbon according to the present invention.

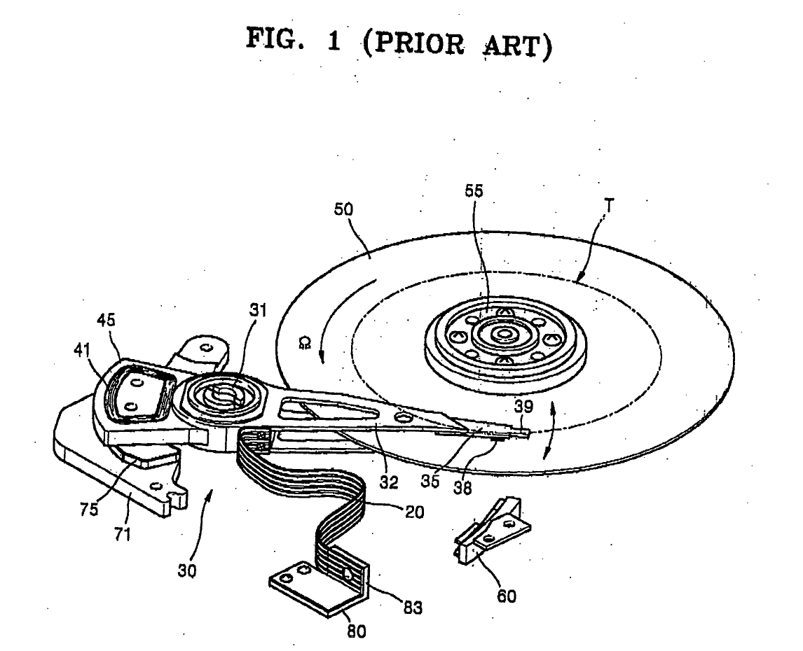

### DETAILED DESCRIPTION OF THE PREFERRED EMBODIMENTS

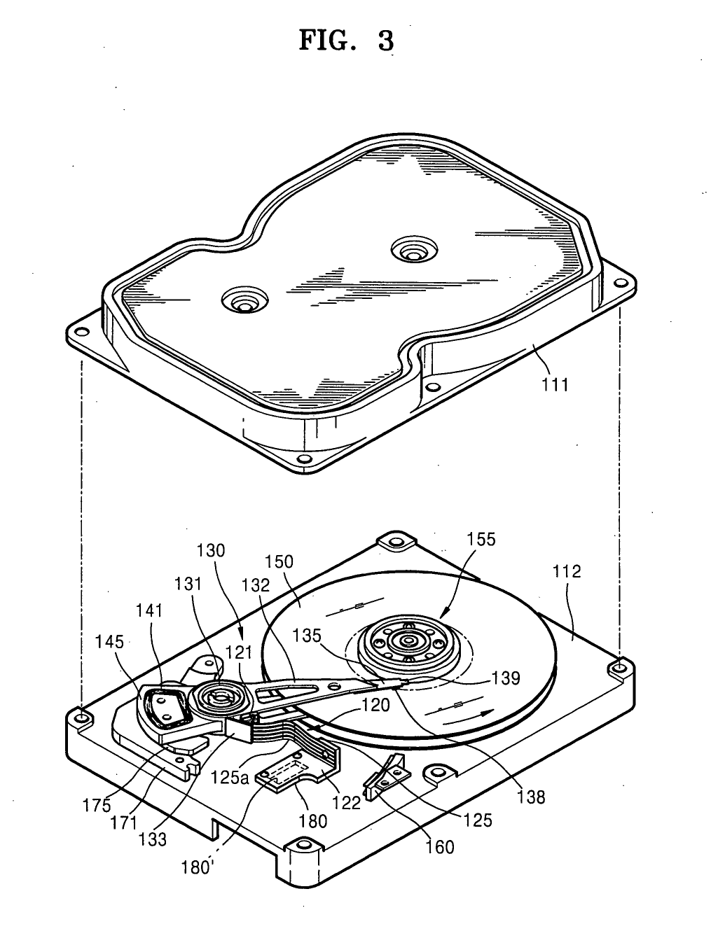

The present invention will now be described more fully with reference to FIGS. 3-12.

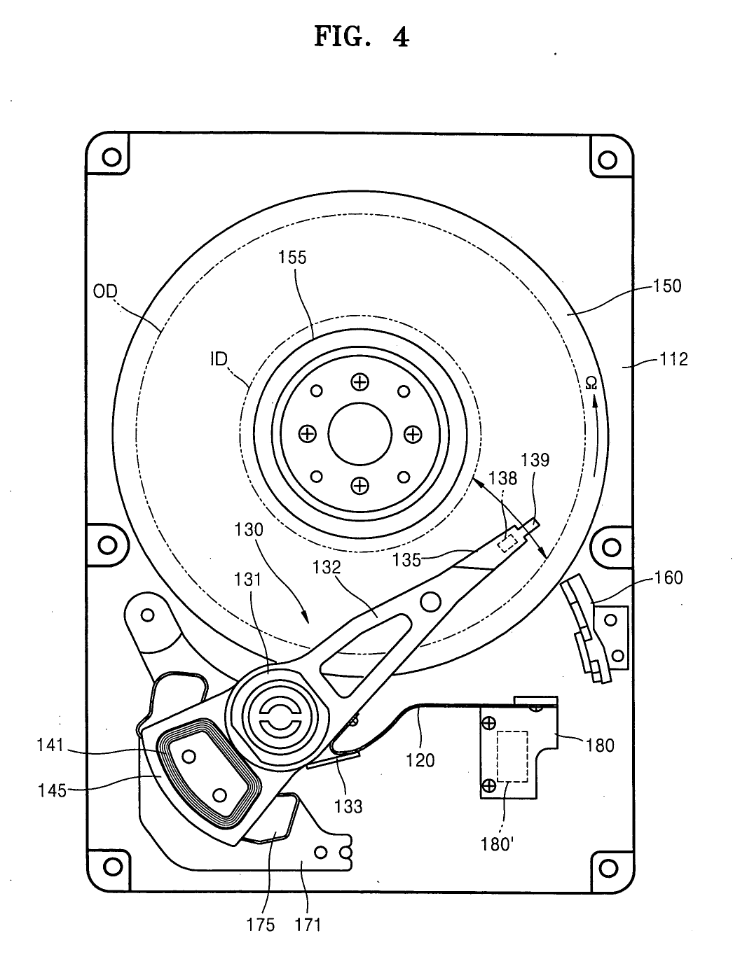

Referring first to FIGS. 3 and 4, the HDD includes a data storage disk 150, a spindle motor 155 for rotating the data storage disk 150 at a constant speed, a read/write head 138, and an actuator 130 for moving the read/write head 138 to a desired position over the disk 150. Although only one disk 150 is shown, a plurality of data storage disks 150 may be mounted to the spindle motor 155. The spindle motor 155 is mounted to a base 112 of the HDD. The actuator 130 includes an actuator pivot 131 disposed on the base 112, a swing arm 132, a suspension 135, the read/write head 138, a coil support 145, and a voice coil motor (VCM). The spindle motor 155 and the actuator 130 are accommodated in a space defined by the base 112 and a cover 111 that are coupled to each other. The base 112 and the cover 111 form a housing that protects the inner components of the HDD from foreign substances in the air outside the housing and muffles the noise produced during operation of the HDD.

The swing arm 132 is rotatably supported by the actuator pivot 131, i.e., is rotatable about a central longitudinal axis of the pivot 131. The suspension 135 is coupled to a leading end of the swing arm 132 to support the read/write head 138 and bias the read/write head 138 toward a surface of the disk 150. The coil support 145 is provided on a rear end of the swing arm 132.

The VCM drives the swing arm 132. To this end, the VCM includes a VCM coil 141 wound around the coil support 145, and magnets 175 disposed above and below the VCM coil 141 as facing the VCM coil 141. The magnets 175 are supported by a yoke 171. The VCM rotates the swing arm 132, in a direction according to Fleming's left-hand rule, due to the interaction between a magnetic field induced by the flow of current through the VCM coil 141 and the magnetic field formed by magnets 175.

When the HDD is powered on and the disk 150 is rotated, the VCM rotates the swing arm 132 in a predetermined direction (e.g., counterclockwise) to load the read/write head 138 on a recording surface of the disk 150. The loaded read/write head 138 is maintained a predetermined distance from the recording surface of the disk 150 by a lift force generated by the rotation of the disk 150. In this state, the read/write head 138 records data onto the recording surface of the disk or reproduces data from the recording surface of the disk 150 as it traces a particular track of the disk 150. Note, the recording surface of the disk 150 refers to that portion of the surface of the disk where data can be effectively stored. Generally, the recording surface of the disk 150 does not occupy the entire surface of the disk 150. Rather, the recording surface of the disk 150 only occupies a portion of the entire surface of the disk 150. That is, an inner peripheral or central portion of the disk 150 is allocated for coupling with the spindle motor 155, and an outer peripheral portion of the disk 150 is allocated for the parking of the read/write head 138. Therefore, the recording surface of the disk 150 is delimited between inner and outer regions of the disk 150, i.e., the recording surface of the disk 150 is delimited between two concentric circles ID and OD having diameters greater than the inner diameter of the disk and less than the outer diameter of the disk, respectively.

The HDD also includes a flexible printed circuit ribbon 120 connected to one side of the swing arm 132. The flexible printed circuit ribbon 120 receives driving power and electric signals from a circuit board disposed beneath the base 112, and transmits the driving power and electric signals to the actuator 130 for controlling the loading/unloading operations. In this respect, a fixed support member, such as a bracket 180 mounted to the base 112, connects the flexible printed circuit ribbon 120 to the circuit board. Furthermore, electric signals can be transmitted to or received from the read/write head 138 through the flexible printed circuit ribbon 120, such that data can be recorded on the disk 150 or read from the disk 150. To these ends, the flexible printed circuit ribbon 120 includes a conductive pattern, e.g., in the form of a plurality of conductive lines, that transmits the electrical signals. For example, the ribbon 120 includes a conductive signal line for transmitting/receiving electric signals to/from the read/write head 138, a ground line for grounding the electronic circuitry of the HDD, and a conductive driving current line for transmitting driving current to the VCM.

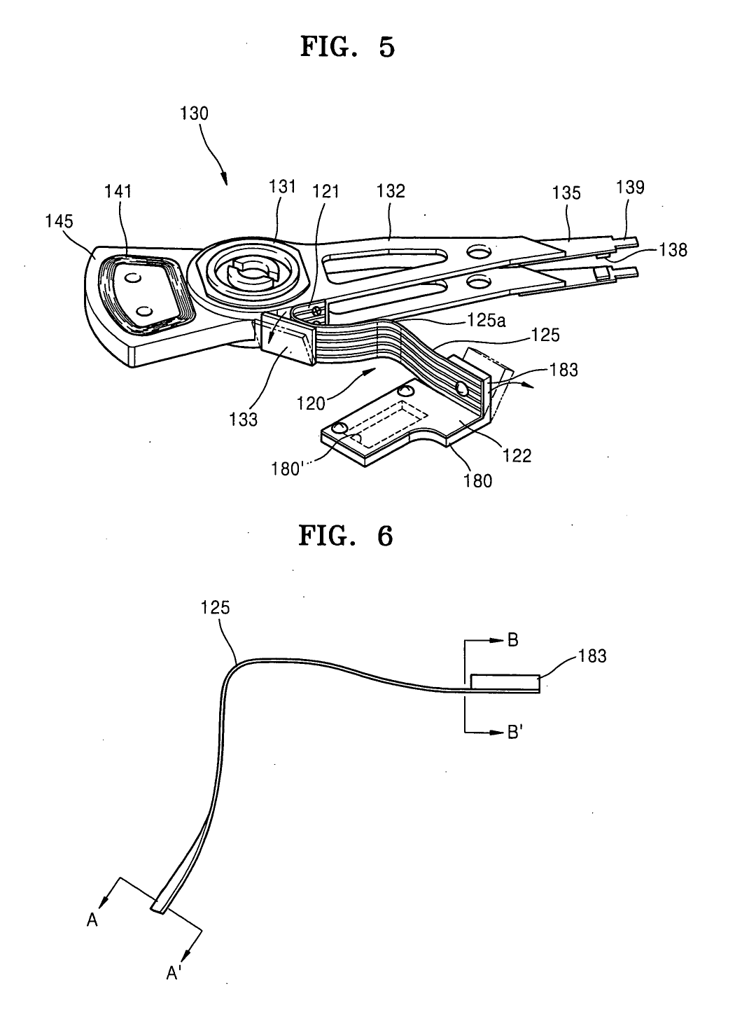

Referring to FIG. 5, the flexible printed circuit ribbon 120 includes a first supported portion 121 abutting the actuator 130, a second supported portion 122 abutting the bracket 180, and a connecting portion 125 extending freely between the first and second supported portions 121 and 122 so as to be relatively free to bend. The first supported portion 121 of the flexible printed circuit ribbon 120 is coupled to the actuator 130. For example, the first supported portion 121 of the flexible printed circuit ribbon 120 is soldered to one side of the swing arm 132. Also, the actuator 130 may include a pressing piece 133 extending from and obliquely to the side surface of the actuator to which the first supported portion 121 of the flexible printed circuit ribbon is coupled. In particular, the pressing piece 133 subtends and acute angle with the side surface of the swing arm 132. The first supported portion 121 is bent between the pressing piece 133 and the side of the actuator 130 and is thereby urged against the actuator 130 by the elasticity of the flexible printed circuit ribbon 120. The second supported portion 122 of the flexible printed circuit ribbon 120 is fixed to an upper portion (leg) of the bracket 180 by a screw, for example. To this, end the second supported portion 122 may have a through hole through which the screw extends. Also, the bracket 180 may have a central opening 180′ extending therethrough for facilitating the connection between the second supported portion 122 and the circuit board (not shown) which is disposed under the bracket 180.

As mentioned above, the connecting portion 125 of the flexible printed circuit ribbon 120 is free to bend and extend. According to the present invention, the connecting portion 125 has enhanced flexibility to minimize the force exerted on the actuator 130 by the flexible printed circuit ribbon 120 especially when the ribbon is bending or unbending. More specifically, the connecting portion 125 has a free bending portion 125a that is substantially thinner than other portions of the flexible printed circuit ribbon. The term “substantially thinner” is used to exclude normal variations that may occur as the result of the manufacturing process, and connotes an ability of the free bending portion 125a to impart a measurably greater flexibility to the printed circuit ribbon than the ribbon would otherwise have without the free bending portion. In particular, the free bending portion 125a imparts a flexibility that has a discernible affect on the bias force exerted by the ribbon on the wing arm 132 as will be described in more detail later on.

The free bending portion 125a extends over a predetermined length of the connecting portion 125. Thus, the free bending portion 125a is more flexible than the other portions of the flexible printed circuit ribbon 120 and consequently, is the first portion of the flexible printed circuit ribbon 120 to bend between the actuator 130 and the bracket 180. The ratio of the over all length of the connecting portion 125 to the length of just the free bending portion 125a, as well as the location of the free bending portion 125a within the connecting portion 125, may be based on specific design specifications, for example, the relative positions of the actuator 130 and the bracket 180 and the distance between the actuator 130 and the bracket 180. In general, the extent and location of the free bending portion 125a are determined to correspond to the location and length of a particular portion of the flexible printed circuit ribbon 120 where the flexible printed circuit ribbon 120 would experience the most bending if it had a uniform thickness as in the prior art.

Consequently, the flexible printed circuit ribbon 120 exerts very little restoring force even when it is twisted when assembled to the actuator 130 and the bracket 80. Accordingly, the predetermined relationship between the magnitude of the driving current supplied to the VCM and the relative angular position to which the swing arm 132 is moved by the VCM is maintained even if the flexible printed circuit ribbon 120 is twisted. Thus, the read/write head 138 can be rapidly moved to a particular target track, i.e., twisting of the flexible printed circuit ribbon 120 hardly impacts the performance of the actuator 130.

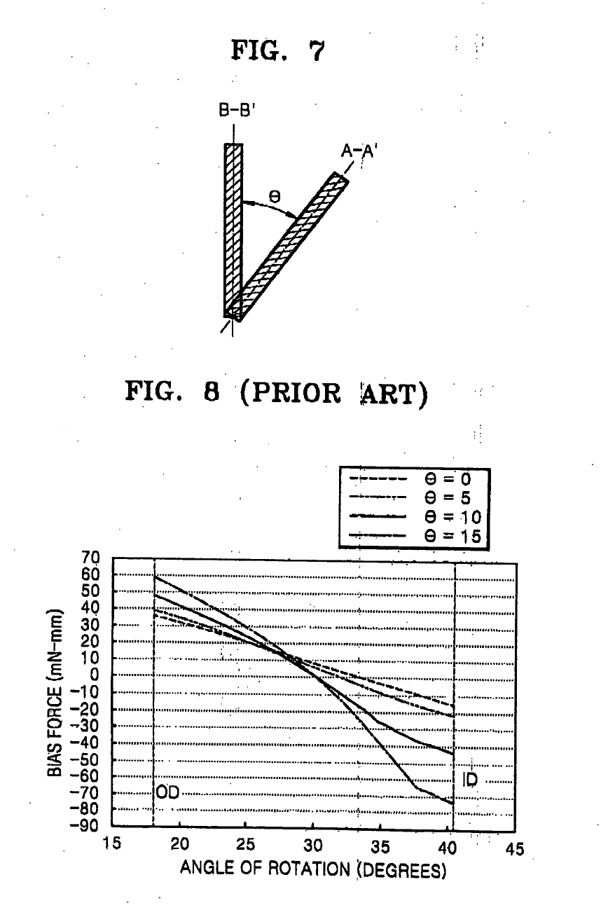

FIG. 6 is a plan view of the flexible printed circuit ribbon 120 depicted in FIG. 5 when the flexible printed circuit ribbon 120 is twisted about 10 degrees, and FIG. 7 illustrates the angle of twist θ between sections of the flexible printed circuit ribbon 120 at lines A-A′ and B-B′ of FIG. 6. Referring to FIG. 7, the angle of twist θ of the flexible printed circuit ribbon 120 can be defined by the maximum angle subtended between sections of the ribbon taken from one end of the connecting portion 125 adjacent to the first supported portion 121 (at line A-A′) and the other end of the connecting portion 125 adjacent to the second supported portion 122 (at line B-B′).

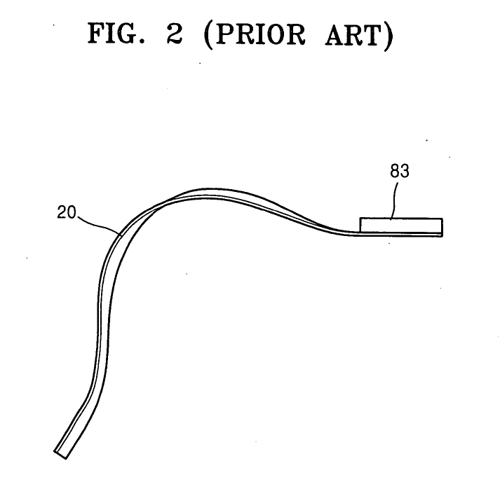

In the present invention shown in FIG. 6, the side of the flexible printed circuit ribbon 120 is observed from above only in a short region where the end of the connecting portion 125 at A-A′ is twisted. On the contrary, in the conventional art as shown in FIG. 2, the sides of the flexible printed circuit ribbon 20 are observed from above over most of the entire length of the flexible printed circuit ribbon 20. This difference is due to the fact that the increased flexibility of the free bending portion 125a of the flexible printed circuit ribbon 120 relaxes the connecting portion 125 according to the present invention. Thus, most of the flexible printed circuit ribbon 120 can be kept in an upright position without twisting.

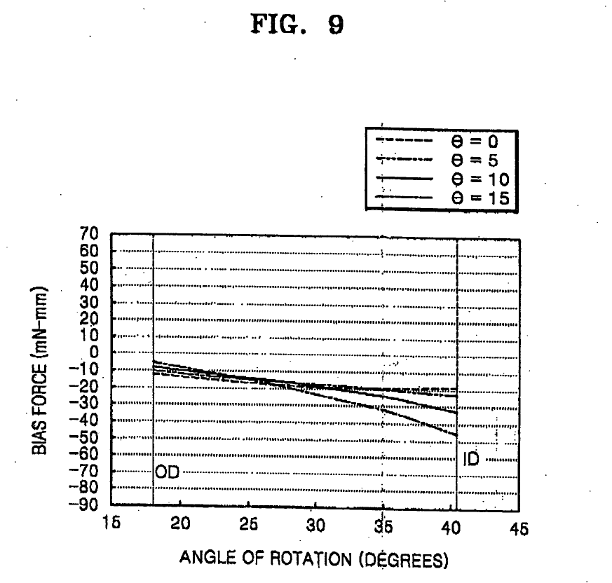

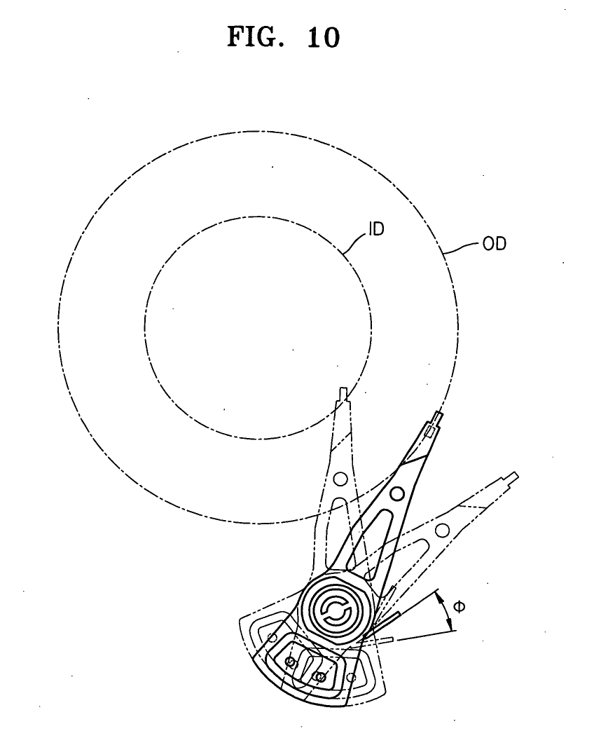

FIGS. 8 and 9 show experimental results of the relationship between bias force and angle of rotation of a swing arm, in the conventional art and the present invention, respectively. In these experiments, the bias force is the force exerted by the flexible printed circuit ribbon on the swing arm in the direction of its rotation while the swing arm is in a free state in which the driving current is not supplied to the VCM. The angle of rotation angle of the swing arm, as shown in FIG. 10, is measured with respect to an arbitrary reference line: the angle of rotation is about 41 degrees when the read/write head lies over the disk along the circle ID, and is about 18 degrees when the read/write lies over the disk along the circle OD. Reference character θ denotes the angle of twist of the flexible printed circuit ribbon as was described with reference to FIG. 7.

In both the conventional art and the present invention, the bias force does become more directly proportional to the angle of rotation of the swing arm, i.e., the plots become more linear, as the angle of twist θ of the flexible printed circuit ribbon becomes smaller. On the contrary, the relationships between the angle of rotation of the swing arm and the bias force become more exponential, i.e., the plots become more curved, as the angle of twist θ becomes greater. However, the present invention is advantageous over the conventional art as Table 1 below shows.

Table 1 offers a comparison between the present invention and the conventional art. In the table, the root mean square error represents the difference between an actual plot of the bias force vs. angle of rotation and a corresponding hypothetical linear plot derived by interpolating measurements of the bias force used to produce the actual plot. Except in the case in which the angle of twist θ is zero, the root mean square error is larger in the conventional art than in the present invention with respect to the same angles of twist θ. In the conventional art, the bias force is far from proportional to the angle of rotation of the swing arm. This means that it is difficult to precisely control the movement of the read/write head to a particular track on the disk. That is, as discussed in the background section, the performance of the conventional HDD is compromised by the relatively long time it takes to move the read/write head over the desired track. On the contrary, in the present invention, the bias force is nearly linear directly proportional to the angle of rotation of the swing arm over an entire range of angles of twist of the flexible printed circuit ribbon. Thus, the read/write head can be rapidly and precisely moved to a particular target track through the use of a controller configured with a simple algorithm that defines the generally linear relationship between the bias force and the angle of rotation of the swing arm.

Also, in Table 1 below, the maximum deviation denotes the difference between the maximum and minimum bias forces with respect to a given angel of rotation of the swing arm. The maximum deviation is relatively larger in the conventional art than in the present invention with respect to the same angles of twist θ. A large maximum deviation, as is present in the conventional art, means that it takes a correspondingly relatively large driving force to move the read/write head across the data zone between the inner circle ID and the outer circle OD, i.e., the operating efficiency of the conventional HDD in driving the swing arm of the actuator is significantly lower than that according to the present invention.

Moreover, tracking errors, in which the read/write head deviates from a particular track during the recording of data onto the track or the reproducing of data from the track, are much more likely to occur in the conventional HDD because of the relatively large bias force exerted on the swing arm. In order to prevent such tracking errors, a force must be applied to the swing arm in its direction of rotation to offset the bias force. However, any such applied force detracts from the efficiency of the HDD in driving the swing arm of the actuator.

TABLE 1

| | | θ = 0 | θ = 5 | θ = 10 | θ = 15 |
|---|---|---|---|---|---|
| Related art | Maximum | 52 | 62 | 92 | 132 |
| | deviation | | | | |
| | Root mean | 0.375 | 1.188 | 2.502 | 6.344 |
| | square error | | | | |
| The present | Maximum | 7 | 12 | 25 | 40 |
| invention | deviation | | | | |
| | Root mean | 1.147 | 0.351 | 0.937 | 1.577 |
| | square error | | | | |

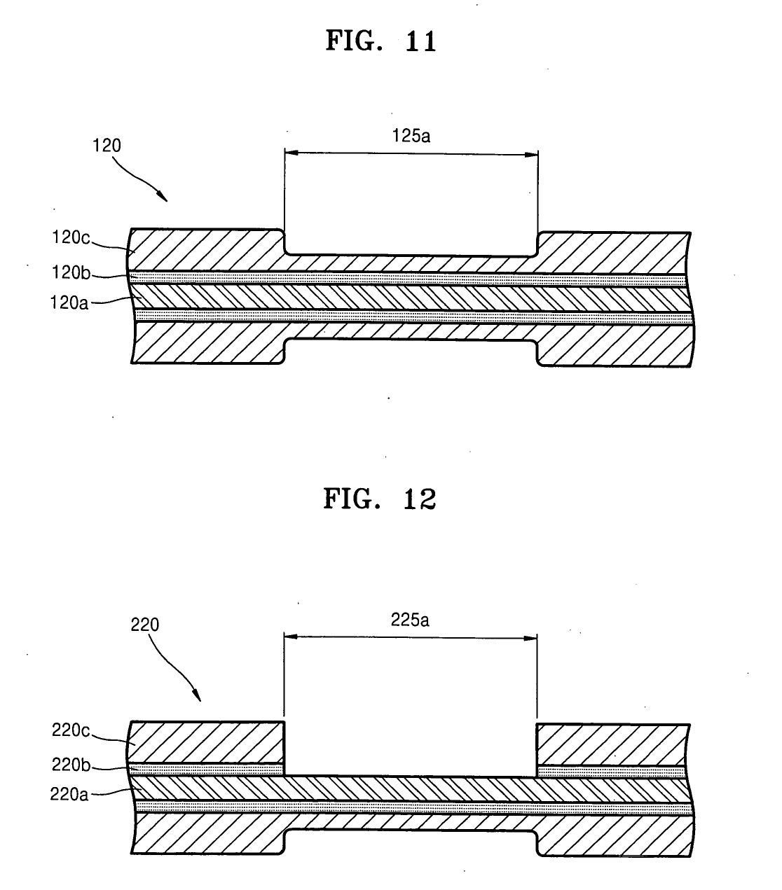

Referring now to FIG. 11, the flexible printed circuit ribbon 120 of the present invention includes a conductive layer 120a, protective layers 120c on opposite sides of the conductive layer 120a, and bonding layers 120b interposed between the conductive layer 120a and the protective layers 120c, respectively. The conductive layer 120a is constituted by a conductive pattern, namely, a pattern of conductive lines, for transmitting/receiving data signals to/from the read/write head and transmitting/receiving driving signals to/from the actuator. The protective layers 120c envelop the conductive layer 120a to prevent short circuits between the conductive lines of the conductive layer 120a and to electrically insulate the conductive layer 120a from the surrounding environment. The bonding layers 120b may comprise an adhesive to bond the conductive layer 120a and the protective layers 120c. In this case, the bonding layers 120b can be applied to both sides of the conductive layer 120a. Alternatively, only one bonding layer 125 may be employed. The conductive layer 120a may be formed of a metal having a high electric conductivity, such as copper. The protective layers 120c may be formed of an insulating material such as polyimide.

The thickness of the conductive layer 120a is preferably uniformly over the entire length of the flexible printed circuit ribbon 120 because the conductive layer 120a is the layer that most affects the electrical performance of the flexible printed circuit ribbon 120. At least one of the protective layers 120c, on the other hand, may have thicknesses that varies over the length of the flexible printed circuit ribbon 120: at least one of the protective layers 120c may be relatively thin at the free bending portion 125a for better flexibility, and relatively thick at all other portions of the flexible printed circuit ribbon 120. In the embodiment shown in FIG. 11, both of the protective layers 120c are thinner at the free bending portion 125a than at all other portions of the flexible printed circuit ribbon 120.

Another form of a flexible printed circuit ribbon 220 according to the present invention is shown in FIG. 12. Like the flexible printed circuit ribbon 120 shown in FIG. 11, the flexible printed circuit ribbon 220 includes a conductive layer 220a for transmitting electric signals, and protective layers 220c covering opposite sides of the conductive layer 220a to insulate the conductive layer 220a. The flexible printed circuit ribbon 220 may further include one or more bonding layers 220b interposed between the conductive layer 220a and at least one of the protective layers 220c to bond the protective layers 220c to the conductive layer 220a. The thickness of the conductive layer 220a is preferably uniform over the entire length of the flexible printed circuit ribbon 220 because the conductive layer 220a is the layer that most affects the electrical performance of the flexible printed circuit ribbon 220. The flexible printed circuit ribbon 220a also has a free bending portion 225a that provides the flexible printed circuit ribbon 220 with a great amount of flexibility. For this, the free bending portion 225a is thinner than the other portions of the flexible printed circuit ribbon 220.

However, the free bending portion 225a may be devoid of one or both of the protective layers 220c. Furthermore, in the case in which the free bending portion 225a is devoid of one of the protective layers 220c, the other protective layer 220c may be relatively thin at the free bending portion 225a. That is, as shown in FIG. 12, one protective layer 220c (at the top of the figure) has a discontinuity at the free bending portion 225a, and the other protective layer 220c (at the bottom of the figure) is relatively thin at the free bending portion 225a.

In the HDD of the present invention, the flexible printed circuit ribbon, which transmits electrical signals to the actuator, has a free bending portion that imparts a higher degree of flexibility to the ribbon. Thus, the bias force exerted on the flexible printed circuit ribbon is minimized and consequently, the HDD has a correspondingly higher efficiency in driving the swing arm of the actuator. Furthermore, the relationship between the relative angular position of the swing arm (angle of rotation) and the magnitude of the current supplied to the VCM remains linear or approximately linear even when the flexible printed circuit ribbon is twisted when assembled in the HDD. Thus, regardless of the twisting of the flexible printed circuit ribbon, the read/write head can be rapidly moved to a target track. That is, the HDD can still have a high performance.

Finally, although the present invention has been particularly shown and described with reference to the preferred embodiments thereof, various changes in form and details, as it will be apparent to those of ordinary skill in the art that, may be made to the preferred embodiments without departing from the true spirit and scope of the present invention as defined by the following claims.

What is claimed is:

1. A hard disk drive comprising:
at least one data storage disk;
a spindle motor to which the disk is mounted;
an actuator including a read/write head, and an arm to which the read/write head is mounted, wherein the arm moves the read/write head over the disk;
a support member that is fixed in the hard disk drive; and
a flexible printed circuit ribbon connected to the arm so as to move therewith and to the fixed support member, the flexible printed circuit ribbon having a free bending portion along the length of the ribbon between locations at which the ribbon is connected to the swing arm and the support member, the free bending portion being substantially thinner than other portions of the flexible printed circuit between said locations,
whereby the free bending portion imparts an increased flexibility to the ribbon to attenuate a force exerted on the arm by the flexible printed circuit ribbon.

2. The hard disk drive of claim 1, wherein the flexible printed circuit ribbon has a first supported portion abutting and supported on the arm of actuator, a second supported portion abutting and supported on the fixed support member, and a connecting portion interconnecting the first and second supported portions, the connecting portion being freely suspended between the first and second supported portions so as to be free to bend and extend as the arm moves relative to the fixed support member, the free bending portion constituting part of the connecting portion.

3. The hard disk drive of claim 2, wherein the first supported portion of the flexible printed circuit ribbon abuts and is coupled to a side of the arm of the actuator, and the actuator includes a pressing piece protruding from the side of the arm of the actuator, the first supported portion freely abutting the pressing piece and having a bend between the pressing piece and the side of the of the arm of the actuator, whereby the pressing piece exerts a force on the first supported portion that urges the first supported portion against the side of the actuator due to its own elasticity.

4. The hard disk drive of claim 2, and further comprising a base on which the actuator is mounted, and wherein the fixed support member is a bracket mounted to the base such that the second supported portion is coupled to the bracket, and the bracket includes an opening confronting the base, whereby the second supported portion and a circuit board disposed beneath the base can be electrically connected via the opening in the bracket.

5. The hard disk drive of claim 1, wherein the flexible printed circuit ribbon comprises a conductive layer, and a first protective layer and a second protective layer disposed over opposite sides of the conductive layer, respectively, and
the conductive layer has substantially the same thickness over the entire length of the flexible printed circuit ribbon between said locations, and at least one of the first and second protective layers is thinner at the free bending portion than at other portions of the flexible printed circuit ribbon between said locations.

6. The hard disk drive of claim 5, wherein the flexible printed circuit ribbon further comprises a respective bonding layer interposed between at least one of the first and second protective layers and the conductive layer, the at least one bonding layer bonding the conductive layer to the protective layers.

7. The hard disk drive of claim 1, wherein the flexible printed circuit ribbon comprises a conductive layer, and a first protective layer and a second protective layer disposed over opposite sides of the conductive layer, respectively, and
the conductive layer has substantially the same thickness over the entire length of the flexible printed circuit ribbon between said locations, and at least one of the first and second protective layers has a discontinuity at the free bending portion.

8. The hard disk drive of claim 7, wherein the flexible printed circuit ribbon further comprises a respective bonding layer interposed between at least one of the first and second protective layers and the conductive layer, the at least one bonding layer bonding the conductive layer to the protective layers.

9. A flexible printed circuit ribbon for use in a hard disk drive, the flexible printed circuit ribbon comprising a conductive layer extending along the length of the ribbon, and a first protective layer and a second protective layer disposed over opposite sides of the conductive layer, respectively, and wherein the flexible printed circuit ribbon has first and second end portions to which the conductive layer extends, and a free bending portion located along the length of the ribbon between the first and second end portions, the free bending portion being substantially thinner than other portions of the flexible printed circuit ribbon located between the first and second end portions, whereby the free bending portion imparts an increased flexibility to the ribbon.

10. The flexible printed circuit ribbon of claim 9, wherein the conductive layer has substantially the same thickness over the entire length of the flexible printed circuit ribbon, and at least one of the first and second protective layers is thinner at the free bending portion than at other portions of the flexible printed circuit between the first and second end portions.

11. The flexible printed circuit ribbon of claim 10, wherein the flexible printed circuit ribbon further comprises a respective bonding layer interposed between at least one of the first and second protective layers and the conductive layer, the at least one bonding layer bonding the conductive layer to the protective layers.

12. The flexible printed circuit ribbon of claim 9, wherein the conductive layer has substantially the same thickness over the entire length of the flexible printed circuit ribbon, and at least one of the first and second protective layers has a discontinuity at the free bending portion.

13. The flexible printed circuit ribbon of claim 12, wherein the flexible printed circuit ribbon further comprises a respective bonding layer interposed between at least one of the first and second protective layers and the conductive layer, the at least one bonding layer bonding the conductive layer to the protective layers.
